(19) United States
(12) Patent Application Publication
(10) Pub. No.: US 2010/0212835 A1
(43) Pub. Date: Aug. 26, 2010

(54) COMBINED ENVELOPE FOR TIRE RETREADING

(76) Inventor: Ricardo Luiz Azevedo Campos Da Silva, Cuiaba-MT (BR)

Correspondence Address: STITES & HARBISON PLLC, 1199 NORTH FAIRFAX STREET, SUITE 900, ALEXANDRIA, VA, 22314, US

(21) Appl. No.: 11/917,960

(22) PCT Filed: Jul. 10, 2006
(86) PCT No.: PCT/BR06/00140

§ 371 Date: Dec. 18, 2007

(30) Foreign Application Priority Data
Jul. 11, 2005 (BR) PI-0502850-7

(51) Int. Cl. B29D 30/54

(52) U.S. Cl. 156/394.1

(57) ABSTRACT

Combined envelope for tire retreading basically comprises a single body (1) without patches, made with vulcanized and flexible rubber, being provided with an internal central bag (2) with a profile that is compatible with the internal part of the tire to be reformed, also having the support ribs (3) of the tire shell beads and an external protective cover (4) that extends itself throughout the contour of the assembly formed by the new tread to be adhered and by the shell of the tire to be reformed, trespassing on the side the rim (5) with sealing rib (6) where the envelope sealing shall be performed, in which it is aided by the air removal, through the valve (7) installed in the envelope, performed by a vacuum pump (not shown).

### FIELD OF APPLICATION

This descriptive report refers to a COMBINED ENVELOPE FOR TIRE RETREADING, which shall be more particularly used in a tire recapping process in autoclave, and which shall be intended to involve the set formed by the new tread to be adhered, by the adhesive layer and by the shell of the tire to be reformed, aiming to be able to provide more practicality and agility in the packing of this set within the envelope, which may be made manually, besides assuring the perfect orientation of the pressure exerted upon the set within the autoclave, where the fusion of the adhesive layer shall occur, with the consequent adhesion and vulcanization of the tread upon the tire shell.

### INVENTION SUMMARY

The COMBINED ENVELOPE FOR TIRE RETREADING proposed herein comprises a rubber artifact which incorporates, in the form of a single body, an internal bag and an external bag, forming an envelope, in which the set formed by the new tread to be adhered shall be packed, by the adhesive layer and by the shell of the tire to be reformed, and may be used in the tire reform process of all types and sizes, including tires for passenger cars, semi-load, load, agricultural, earthwork and industrial vehicles, whereby the external bag shall involve the whole external surface of the new tread to be adhered and of the side surface of the shell of the tire to be reformed, whilst the internal bag shall be intended to recover the whole internal surface of the shell of the tire to be reformed, in order to direct the internal pressure in the autoclave upon the tread to be adhered, thus avoiding the possibility of its displacement, thus guaranteeing its perfect adhesion and vulcanization upon the shell of the tire to be reformed.

The COMBINED ENVELOPE FOR TIRE RETREADING proposed herein may also be used to assure the perfect adhesion and finishing of repairs performed to restore eventual damages in the tire shell structure, which are normally made through the application of patches applied in the internal part of its shell, and due to the functional characteristics of this envelope, the application of an equalized pressure in all points of the tire to be reformed shall be possible; that is, not only in the new tread to be adhered, but also in the internal and external surfaces of the shell of the tire to be reformed, thus assuring that the patch shall not be submitted to a pressure different from the internal pressure of the autoclave, thus avoiding that it may suffer deformations in the most critical repair region.

### TECHNIQUE BACKGROUND

Since several types of envelopes that are used in the tire recapping process are already known in the technique state of the art, and the most usual ones are those which are configured in the form of a protective layer which is disposed upon the external surface of the tread to be adhered and the side surfaces of the tire to be reformed, and that associated to that kind of envelope, rings are also used, provided in the central part of the tire, to retain an inner tube that is applied within the shell of the tire to be reformed, forming an element of resistance to the autoclave internal pressure; however, such type of assembly presents as its main nuisance the fact that it is not able to guarantee a perfect distribution of the autoclave internal pressure upon the tread to be adhered, resulting most of the times, in its deformation; besides, the assembly of the envelope generates a high expenditure of time and labor, which, consequently, contributes to a decrease in the recapping process yield.

It is also known by the state of the technique the envelope proposed in the document of the U.S. Pat. No. 6,261,409, which is intended to the use of the tire recapping, comprising two parts, being one internal part of the envelope disposed upon the whole internal region of the shell of the tire, which extends itself on part of its outside walls and that, upon the ends of the said internal part of the envelope, the outside part of the envelope shall be assembled, which covers the tread to be adhered, which extends itself on part of the outside walls of the shell of the tire; however, this type of envelope presents as its main disadvantage the fact of requiring the use of an enveloping machine to perform the assembly of the internal and external parts which interconnect the envelope, which makes it necessary to physically shift the set in the performance area of the recapping process, thus creating a higher consumption of time and labor for its performance, in addition to due to the fact that the internal and external parts of the envelope are overlapped to the other, union areas are created that extend along the whole side part of the assembly formed by these said internal and external part, thus increasing the possibility of occurring leaks.

It is also known by the state of the technique the document of U.S. Pat. No. 6,406,282, which deals with an external envelope associated to a sealing set that is provided in the central edge of the tire to be reformed; however, this type of envelope presents as its main nuisance, besides requiring the use of its own machinery to be assembled, and the biggest possibility of leaks occurrence, as a function of the union areas that are formed in the envelope sides, the fact of the installation of the sealing set at the central edge of the tire to be reformed requiring a significant expenditure of time and labor for its installation, without counting with the fact that, due to the lack of an element able to promote a counter-pressure within the shell of the tire to be reformed, a deformation of the tread to be adhered may occur.

### Invention Grounds

In order to overwhelm all nuisances resulting from the present techniques, a COMBINED ENVELOPE FOR TIRE RETREADING was idealized, the use of which shall provide a decrease of approximately 30% in the assembly time of the tire to be reformed, when compared to the present procedures, increasing the safety level of the process regarding the occurrence of eventual leaks, thus avoiding any type of commitment of the tire rebuilding process and repairs finishing, completely eliminating the requirement of using reinforced inner tubes, wheel protector or metallic rings in the retreading process, generating an economy in the order of 50% for the reformer, significantly increasing the safety of the repaired areas, thus contributing, consequently, to increase the final quality of the reformed tire.

The COMBINED ENVELOPE FOR TIRE RETREADING proposed herein is basically comprised of a single body, made from vulcanized and flexible rubber in dimensions compatible with the type of tire to be reformed, being provided with an internal central bag, with a profile that is identical to the internal part of the tire to be reformed, also having the support bands of the tire shell beads, and an external protective cover that extends itself for the whole contour of the assembly formed by the new tread to be adhered and by the shell of the tire to be reformed, crossing the rim with sealing bead over the side, where the envelope sealing shall be made, being aided by the air removal through the valve installed in the envelope, and which shall be performed by a vacuum pump.

### BRIEF DESCRIPTION OF THE DRAWINGS

In order to better understand the COMBINED ENVELOPE FOR TIRE RETREADING, reference is made to the enclosed drawings, in which:

FIG. 1—Shows a perspective view of the combined envelope for tire retreading;

FIG. 2—Shows a semi-sectioned perspective view of the combined envelope for tire retreading;

FIG. 3—Shows a semi-sectioned perspective view of the combined envelope with the tire installed within it;

FIG. 4—Shows a top view of the combined envelope for tire retreading;

FIG. 5—Shows a bottom view of the combined envelope for tire retreading;

FIG. 6—Shows a side view of the combined envelope for tire retreading;

FIG. 7—Shows a cross-section side view of the combined envelope for tire retreading;

FIGS. 8 to 11—Shows the movements sequence that precedes the installation of the tire in the combined envelope;

FIGS. 12 to 15—Shows the movements sequence of the tire installation in the combined envelope.

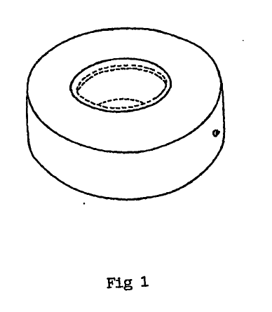

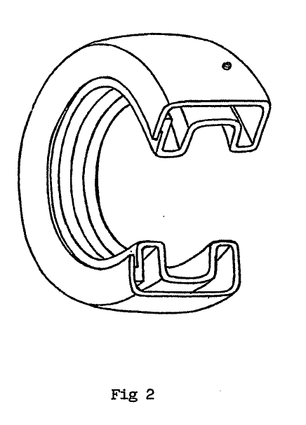

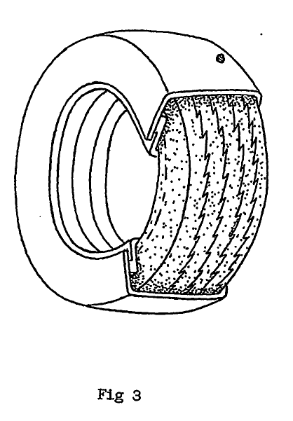

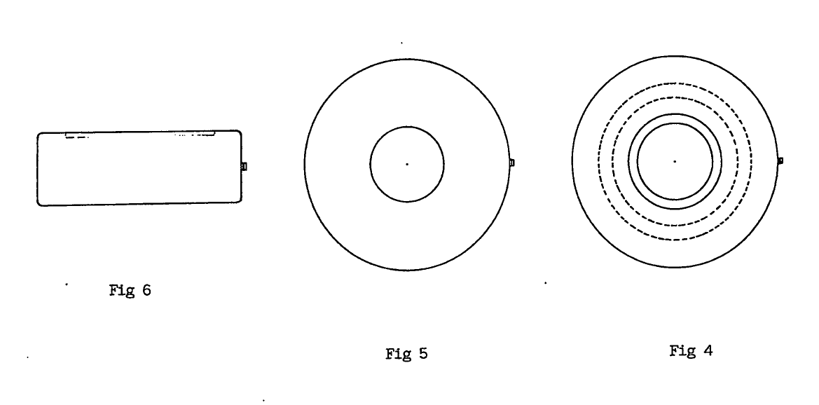

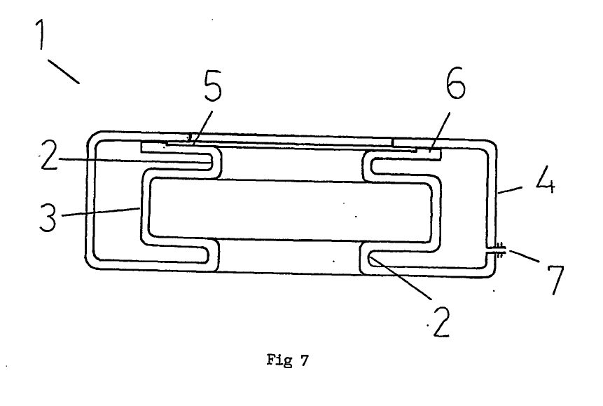

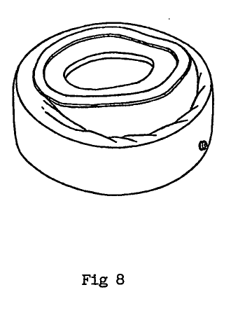

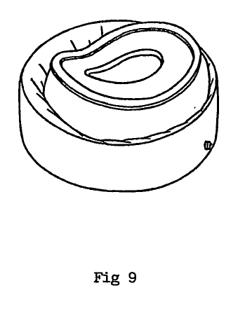

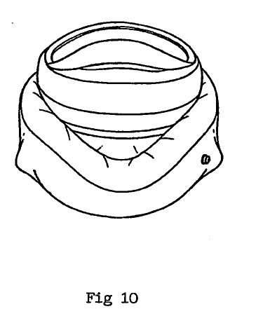

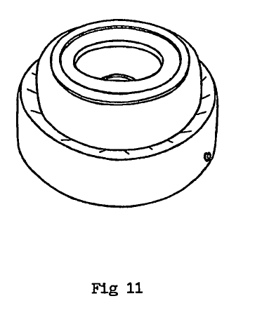

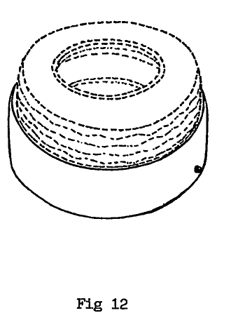

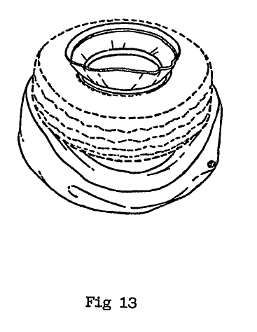

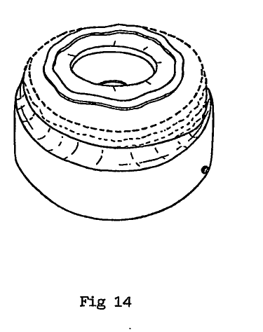

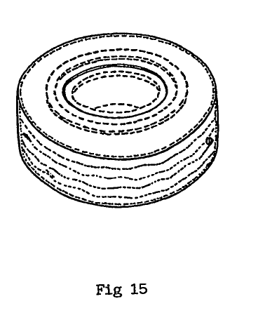

### PREFERRED INVENTION DESCRIPTION

In compliance with what the figures enclosed show, the COMBINED ENVELOPE FOR TIRE RETREADING basically comprises a single body (1) without patches, made with vulcanized and flexible rubber, being provided with an internal central bag (2) with a profile that is compatible with the internal part of the tire to be reformed, also having the support ribs (3) of the tire shell beads and an external protective cover (4) that extends itself throughout the contour of the assembly formed by the new tread to be adhered and by the shell of the tire to be reformed, trespassing on the side the rim (5) with sealing rib (6) where the envelope sealing shall be performed, in which it is aided by the air removal, through the valve (7) installed in the envelope, performed by a vacuum pump (not shown).

In practice, the operator should pull the side rim in order to distend the internal central bag off the envelope; the bag shall be introduced through the central orifice of the tire to be reformed, and subsequently, the said central internal bag should be internally arranged in the tire shell, and its external surface should be involved by said external protective cover, and the said side rim arranged under the peripheral edge of said external protective cover, and after that, a vacuum pump shall be installed through a hose of its own (not shown), in the valve foreseen in the envelope, in order to remove all the air inside it, making the internal and external surfaces of the envelope conform to the internal and external surfaces of the tire to be reformed, making the sealing rib of the side rim to be pressed against the internal peripheral edge of the external protective cover, keeping an adjusted assembly of the envelope upon all the areas of the tire to be reformed; after that, the whole assembly may be introduced in the autoclave, so that one may process the vulcanization of the tread or of the patch on the tire shell, and all such procedure may be performed manually in a quick and practical form, and totally safe against the occurrence of leaks, besides propitiating also when in service, the perfect distribution of the pressure exerted within the autoclave, along all the areas of the tire to be reformed, thus assuring an excellent quality vulcanization.

1. COMBINED ENVELOPE FOR TIRE RETREADING, characterized by the fact of being basically comprised of a single body (1) without patches, made of vulcanized and flexible rubber having dimensions that are compatible with the type of tire to be reformed, being provided with an internal central bag (2), having a profile compatible with the internal part of the tire to be reformed, also having the support ribs (3) of the tire shell beads, the external protective cover (4) which extends throughout the contour of the set formed by the tread and by the shell of the tire to be reformed, trespassing on the sides the rim (5) with sealing rib (6), where the envelope sealing shall be performed, in which it is aided by the air removal, performed by a vacuum pump (not shown), which shall be installed in the envelope's valve (7).

2. COMBINED ENVELOPE FOR TIRE RETREADING, according to claim 1, characterized by the fact that the sealing rib may be positioned in any location of the tread.

3. COMBINED ENVELOPE FOR TIRE RETREADING, according to claim 1, characterized by the fact that the seating rib may be positioned in any location in the internal part of the tire to be reformed.

4. COMBINED ENVELOPE FOR TIRE RETREADING, according to claim 1, characterized by the fact that the sealing rib may have the rectangular form.

5. COMBINED ENVELOPE FOR TIRE RETREADING, according to claim 1, characterized by the fact that the sealing rib may have the round form.

6. COMBINED ENVELOPE FOR TIRE RETREADING, according to claim 1, characterized by the fact that the sealing rib may have the form combined of a rectangle with triangular stretches in the ends.

7. COMBINED ENVELOPE FOR TIRE RETREADING, according to claim 1, characterized by the fact that the sealing rib may have a metallic ring reinforcement.

8. COMBINED ENVELOPE FOR TIRE RETREADING, according to claim 1, characterized by the fact that the support beads are reinforced regarding the rest of the envelope.

9. COMBINED ENVELOPE FOR TIRE RETREADING, according to claim 1, characterized by the fact that the reinforcement of the support ribs may be achieved through the increase in the envelope wall thickness in that area.

10. COMBINED ENVELOPE FOR TIRE RETREADING, according to claim 1, characterized by the fact that the reinforcement of the support ribs may be achieved through the combination of rubber and textile fibers.

11. COMBINED ENVELOPE FOR TIRE RETREADING, according to claim 1, characterized by the fact that the reinforcement of the support ribs may be achieved through the combination of rubber and metal.

12. COMBINED ENVELOPE FOR TIRE RETREADING, according to claim 1, characterized by the fact that the envelope stretch that covers the tread may have one or more reinforcement points.

13. COMBINED ENVELOPE FOR TIRE RETREADING, according to claim 1, characterized by the fact that the reinforcement of the stretch of the envelope that covers the tread may be achieved by the thickness increase in that area.

14. COMBINED ENVELOPE FOR TIRE RETREADING, according to claim 1, characterized by the fact that the reinforcement of the stretch of the envelope that covers the tread may be achieved by the combination of rubber and textile fibers.

15. COMBINED ENVELOPE FOR TIRE RETREADING, according to claim 1, characterized by the fact that the reinforcement of the stretch of the envelope that covers the tread may be achieved by the combination of rubber and metal.
